(19) United States
(12) Patent Application Publication
(10) Pub. No.: US 2021/0160971 A1
(43) Pub. Date: May 27, 2021

(54) ELECTROMAGNETIC INTERFERENCE CONFLICT RESOLUTION FOR MULTIPLE INDUCTION HEATER CONTROL

(71) Applicant: Siu Ming Yung, Shatin (HK)

(72) Inventor: Siu Ming Yung, Shatin (HK)

(21) Appl. No.: 16/693,346

(22) Filed: Nov. 24, 2019

(51) Int. Cl. H05B 6/06; H02J 50/12; H02M 7/537; H02M 1/44; H05B 6/12

(52) U.S. Cl. CPC H05B 6/065; H02J 50/12; H02M 2001/0009; H02M 1/44; H05B 6/1209; H02M 7/537

(57) ABSTRACT

The present invention relates to induction heater control method, control device and multiple induction heater devices, the induction heating control method base on setting one of the multiple induction heater as main and the others heaters as auxiliary. The induction heater energy exchange cycle includes trigger and cut off periods, while the main heating device is in the cut off period, the auxiliary device is triggered, and while the auxiliary device is in the cut off period, the main heating device is triggered, both heating device can generate heat alternately. Using the control method and control device, multiple induction heaters can work under each other's interferences in a controlled fashion, provides more cooking options such as contact grill with heating devices facing each other while operating.

### FIELD OF THE INVENTION

The present invention relates to an induction heater control system and more specifically to an induction heater control system which allows multiple induction heaters to work under each others' interference.

### BACKGROUND OF THE INVENTION

Heating device that is heated up through direct electromagnetic energy conversion is called “induction heater”. Inductor heater is so designed with the following shortcomings:
1. The existence of external interference, for example:
   a. Energy converting coil, resonant capacitor and driving IGBT of the inverter are considered as power switching and parallel LC resonant operation, so only the IGBT collector voltage and the voltage between the terminals of the energy converting coil are measured, these are used as synchronize signal to determine whether or not it is safe to turn on the IGBT.
   b. Simple overall current measurement uses low value resistance or current sensor without knowing the current flowing through the energy converting coil;
2. For simplicity of circuitry, the said voltage and current measurements are performed using Micro Controlling Unit. Over voltage and/or over current damage to electronic device could happen before the Micro Controlling Unit could react;
3. Without handling the high frequency harmonic generated from the pulse width modulation, EMC interference to other appliances is generated.

Owning to the said shortcoming, the present induction heaters are working alone, it is quite difficult for them to form array of heating devices that work under each other's interference.

### SUMMARY OF THE INVENTION

The present invention relates to induction heater control method, control device and multiple induction heater device, said control method triggers the auxiliary heating device synchronizing with the main heating device energy exchange cycle so that main and auxiliary exchange energy alternatively, synchronization allows multiple induction heaters work under each other interferences in a controlled fashion.

The induction heater energy exchange cycle includes trigger and cut off periods. The cycles are controlled by Micro Control Unit, while the main heating device is in the cut off period, the auxiliary device is triggered, and while the auxiliary device is in the cut off period, the main heating device is triggered, both heating device can generate heat as if they are working alone. Using the control method and control device, multiple induction heaters can work under each other's interferences, providing more cooking options such as contact grill with heating devices facing each other while operating.

### DETAILED DESCRIPTION OF THE INVENTION

The aim of the present invention is to provide induction heater controlling method, control device and induction heater device that overcome the insufficiency of the present induction heater technology.

The present invention adapts an induction heater control method; the induction heater consists of energy converting coil, and the connected driving inverter, IGBT module and a capacitor connected in parallel with the energy converting coil to form a LC resonant circuit, energy exchange of induction heating device is based on each time the IGBT module is triggered by the connected driving inverter, making the IGBT conducts, current flows from the Power Source through the LC parallel circuit, the IGBT module's D and then S terminals to the ground; current stores the magnetic energy in the coil L; when the energy is absorbed by a good magnetic conducting cookware, induced eddy current on the cookware generates heat; when the pulse stop, the IGBT module cut off, magnetic energy that is not absorbed will charge up the capacitor; LC parallel resonant circuit determines the duration of the cut off, the triggering pulse will begin again after the voltage across the LC resonant circuit diminish. The energy exchange cycle consist of trigger and cut off periods; the induction heater control method bases on setting one of the multiple induction heating devices as the main device, and by triggering the other auxiliary heating devices while the main device is in its cut off period, allowing main and auxiliary heating devices heat up alternatively, synchronization of the alternate triggering brings the interference of the main and auxiliary heating device to a relatively low and predictable fashion, as the Main and auxiliary heating devices are controlled by synchronization circuit. While the main heating device is in its cut off period the auxiliary device is triggered; with N heating devices, with Tm being the triggering cycle period of the main device, triggers of equal distance Tm/N are applied to the auxiliary heating devices, multiple heating devices can exchange energy simultaneously.

The present invention also provide an induction heater control device; the induction heater consists of an energy converting coil connected in parallel with a capacitor to form a LC resonant circuit, with one end of the said LC resonant circuit connects to the supply while the other end connects to an IGBT module; said IGBT module connects to driving inverter, a control device connects to the driving inverter which can trigger the inverter to start the energy exchange cycle. Said control device also consists of voltage detector connecting in parallel with the said energy converting coil and a current detector connecting in series with the said IGBT module which monitor the energy converting cycles, said control device connects to a synchronization circuit that is also connected to multiple induction heater control devices; said synchronization circuit monitors energy converting cycles and controls all connected induction heater control devices by setting one of the multiple induction heating control devices as main device, and by triggering the other auxiliary heating devices while the main device is in its cut off period, allowing main and auxiliary heating devices heat up alternatively.

As a preferred embodiment, the said synchronization circuit is implemented by using micro control unit, but it can also be any sequential logic circuit.

The present invention also provide a multiple induction heating device that consists of as least two induction heater aligned in any orientation, each induction heater consists of energy converting coil connected in parallel with a capacitor to form a LC resonant circuit, with one end of the said LC resonant circuit connects to the supply while the other end connects to an IGBT module; said IGBT module connects to driving inverter, each induction heater also consists of control device connects to the driving inverter which can trigger the inverter to start the energy exchange cycle; Said control device also consists of voltage detector connecting in parallel with the said energy converting coil and a current detector connecting in series with the said IGBT module which monitor the energy converting cycles.

As a preferred embodiment, said multiple induction heating device includes two induction heaters with their energy converting coil facing each other.

As another embodiment, said multiple induction heating device includes multiple induction heaters with their energy converting coil pointing towards the same center.

By utilizing the said control device and method, multiple induction heaters can work under each other's interference. Multiple induction heaters can be employed to work as a more effective heating device that fulfills the actual needs of cooking.

### BRIEF DESCRIPTION OF THE DRAWINGS

Embodiments of the invention will now be described by way of example only and with reference to the accompanying drawings, in which:

FIG. 1 shows a block diagram of the connection of the inductor heater control system employing the present invention;

FIG. 2 shows the connection of the voltage detection device employing the present invention;

FIG. 3 shows the connection of the current detection device employing the present invention;

FIG. 4 Superimposed voltage signals sensed by both devices under interference while employing the present invention;

FIG. 5 Superimposed current signals sensed by both devices under interference while employing the present invention;

FIG. 6 shows two induction heaters employing the present invention working under each other's interference;

FIG. 7 shows a side elevation of a contact grill employing the present invention.

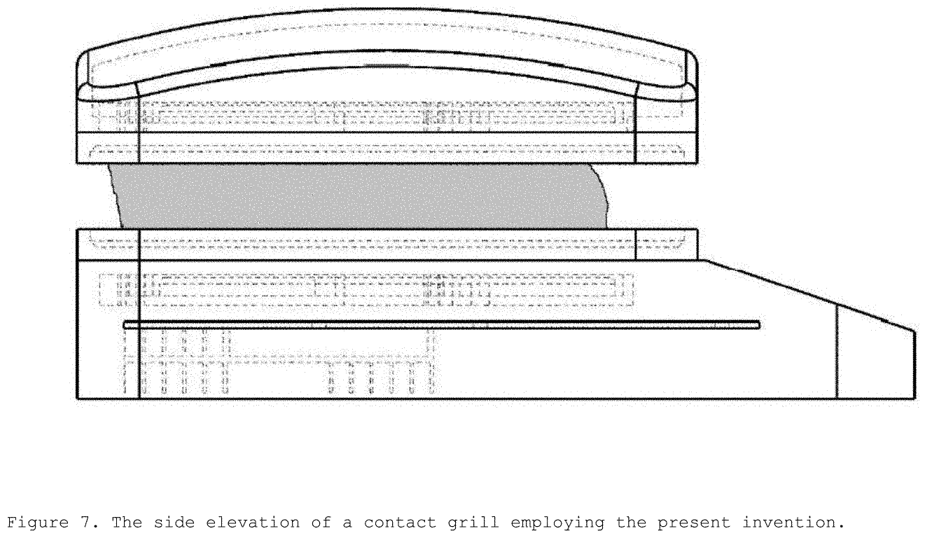

### DETAILED DESCRIPTION OF THE PREFERRED EMBODIMENTS

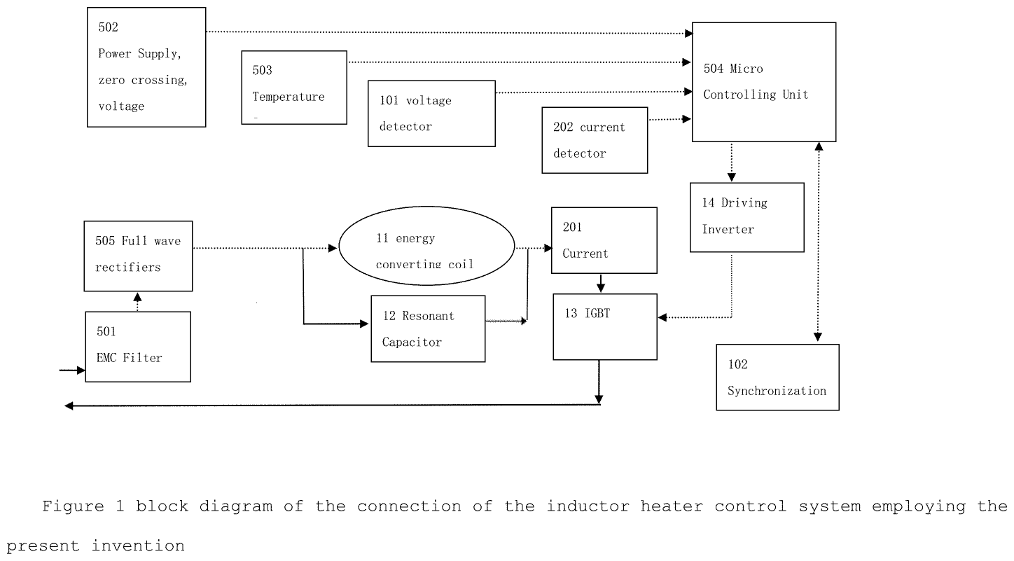

As shown in FIG. 1, the present invention is an induction heater control method, one out of multiple induction heaters consists of energy converting coil 11, and the connected driving inverter 14, IGBT module 13 and a capacitor 12 connected in parallel with the energy converting coil 11 to form a LC resonant circuit, the method to control the induction heating device is based on measuring the current flow through the LC resonant circuit and the IGBT 13, and also the voltage across the LC resonant circuit, in which the current flow through the IGBT 13 is sensed by current sensor 201, the current detector 202 and the voltage detector 101 are calculated by the connected Micro control unit 504, driving inverter 14 and the synchronization circuit 102 are also connected to micro control unit 504, by triggering the driving inverter 14 after determining the cut off period from the said voltage and current, micro control unit 504 provides a safe working cycle for the induction heater; and by triggering the driving inverter at the more specific time as distributed by the synchronization circuit.

Said control method is based on setting 601 of the multiple induction heater device 601 and 602, as the main device, and by triggering the auxiliary device 602 while the main device 601 is in the cut off period of the energy exchange cycles so that both the main device 601 and the auxiliary device 602 can provide heat alternatively, with the interference keep to a relatively low and predictable fashion.

The synchronization of the main and auxiliary devices are achieved by connecting the synchronization circuit 102 of the heating device 601 are connected to the synchronization circuit 102 of the heating device 602.

By connecting the control devices as described above, measurements of current detector 202 and voltage detector 101 can reflect practical operations such as loading and energy exchange timing, coping also with the main and auxiliary status of the devices, each device can accurately trigger individual driving inverter 14 to provide a safe operating condition for all devices.

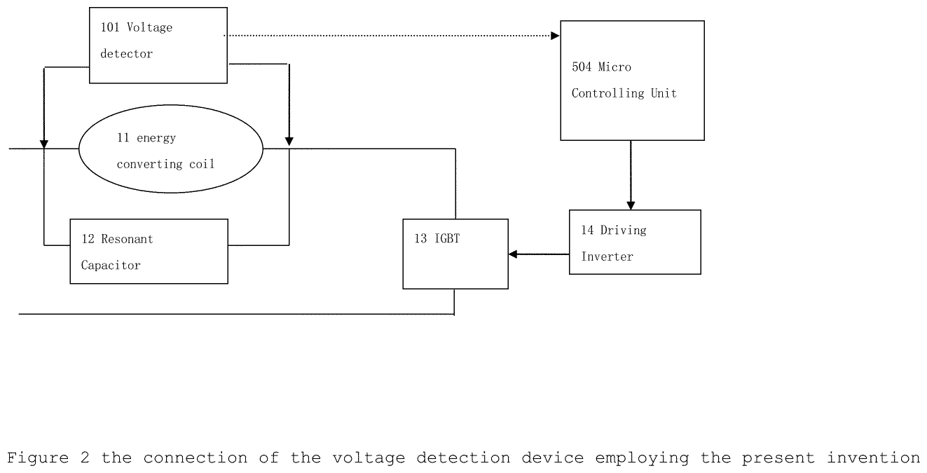

As shown in FIG. 2, the voltage detector 101 is connected across the converting coil 11, can monitor the voltage while the IGBT 13 is in its cut off period in which the capacitor 12 will be charged up and diminish according to the LC resonant nature.

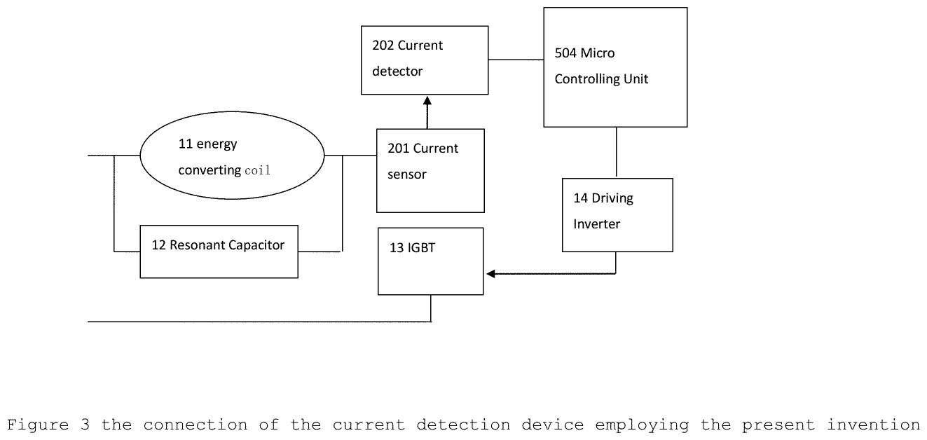

As Shown in FIG. 3, the current sensor 201 is connected in series with the IGBT 13, preferably using a low value resistance, the voltage develops on the said low resistance sensor 201 is amplified and low passed by the current detector 202, can monitor the loading of the operation.

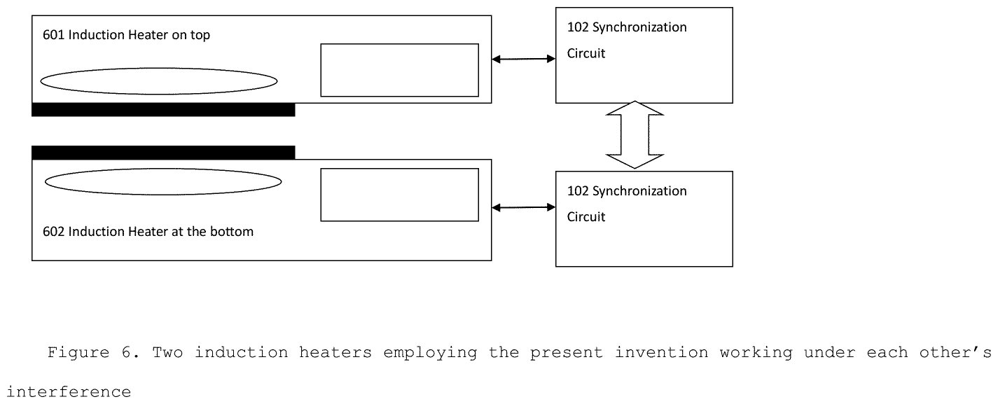

The present invention provide a multiple induction heating device including as least two induction heating devices with arbitrary alignment, each heating device consists of energy converting coil 11, and the connected driving inverter 14, IGBT module 13 and a capacitor 12 connected in parallel with the energy converting coil 11 to form a LC resonant circuit. As show in FIG. 6, as a preferred embodiment, said multiple induction heating device includes two induction heating devices with the energy converting coil facing each other, which is a common arrangement for cooking devices such as waffle maker and contact grill; with the present invention, both heating can heating up effectively. As another embodiment, energy converting coil of multiple heating devices are pointing towards the same center, making an array of heaters that provide a bigger heating volume.

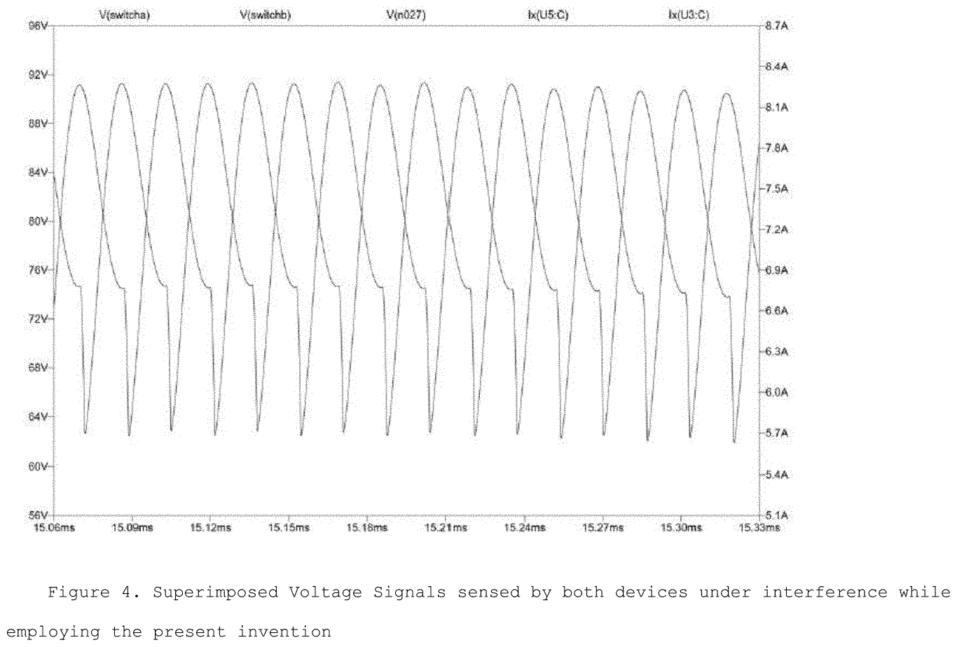

As shown in FIG. 4, voltage signals sensed by both devices under interference while employing the present invention are superimposed together showing no significant distortion from each other's existence.

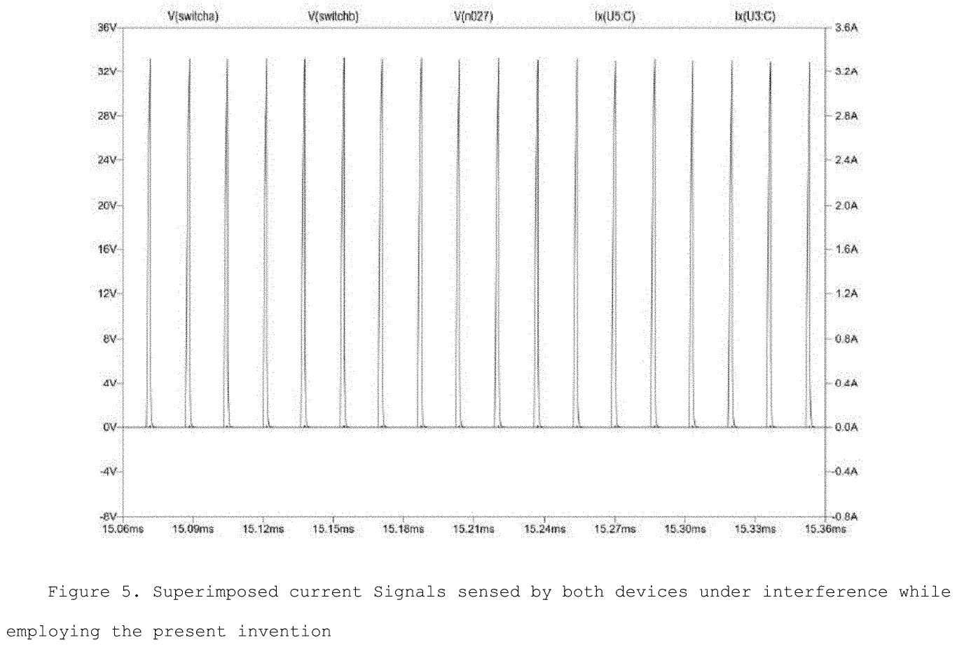

As shown in FIG. 5, current signals sensed by both devices under interference while employing the present invention are superimposed together showing no significant distortion from each other's existence.

The above embodiments described the theory and practical consideration of the present invention. These descriptions present the theory and principle of the invention, cannot be interpreted as limitations to the area as protected by this invention, any other embodiments and variations within the spirit and scope of the invention are anticipated.

What is claimed is:

1. An induction heater control method comprising the induction heater consists of energy converting coil, and the connected driving inverter, IGBT module and a capacitor connected in parallel with the energy converting coil to form a LC resonant circuit, energy exchange of induction heating device is based on each time the IGBT module is triggered by the connected driving inverter, making the IGBT conducts, current flows from the Power Source, through the LC parallel circuit, then the IGBT module D and then S terminals to the ground; current stores the magnetic energy in the coil L; when the energy is absorbed by a good magnetic conducting cookware, induced eddy current on the cookware generates heat; when the pulse stop, IGBT module cut off, magnetic energy that is not absorbed will charge up the capacitor; LC parallel resonant circuit determines the duration of the cut off, The energy exchange cycle consist of trigger and cut off periods; the induction heater control method bases on setting one of the multiple induction heating devices as main device, and by triggering the other auxiliary heating devices while the main device is in its cut off period, allowing main and auxiliary heating devices heat up alternatively, synchronization of the alternate triggering make the interference of the main and auxiliary heating devices to a relatively low and predictable fashion; main and auxiliary heating devices are controlled by synchronization circuit, while the main heating device is in its cut off period the auxiliary device is triggered; for N heating devices, with Tm being the triggering cycle period of the main device, triggers of equal distance Tm/N are applied to the auxiliary heating devices.

2. An induction heater control device comprising the induction heater consists of energy converting coil, and the connected driving inverter, IGBT module and a capacitor connected in parallel with the energy converting coil to form a LC resonant circuit, the control device that connects to the driving inverter also connects to the signal detectors, simultaneously connects to the Micro control Unit and the synchronization circuit.

3. The induction heater control device of claim 2 wherein said signal detector is a voltage detector connects in parallel with the said LC resonant circuit and a current detector connects in series with the said IGBT.

4. The induction heater control device of claim 2 wherein said synchronization circuit is implemented using sequential logic circuit.

5. The induction heater control device of claim 2 wherein said synchronization circuit is implemented using any circuit not limited to micro control unit.

6. A multiple induction heater device comprising as least two induction heaters aligned in any orientation, each induction heater consists of energy converting coil, and the connected driving inverter, IGBT module and a capacitor connected in parallel with the energy converting coil to form a LC resonant circuit, each induction heater also consists of its control device, said control device consists of Micro Control unit, driving inverter and signal detector, said signal detector includes voltage detector and current detector.

7. A multiple induction heater device of claim 6 wherein said induction heaters includes two induction heaters with the energy converting coils facing each other.

8. A multiple induction heater device of claim 6 wherein said induction heaters includes multiple induction heaters with the energy converting coils equal distance from and pointing towards the same center.
